(19) United States
(12) Patent Application Publication
(10) Pub. No.: US 2011/0311756 A1
(43) Pub. Date: Dec. 22, 2011

(54) Packaging material with food dye

(75) Inventors: Denny Wüstner, Kaufbeuren (DE); Thomas Klaus, Wolfertschwenden (DE)

(73) Assignee: Huhtamaki Ronsberg ZN der Huhtamaki Deutschland GmbH & Co., KG, Ronsberg/Allgau (DE)

(21) Appl. No.: 12/984,871

(22) Filed: Jan. 5, 2011

(30) Foreign Application Priority Data
Jan. 5, 2010 (DE) 10 2010 000 695.5

(51) Int. Cl. B32B 3/02; B32B 3/00

(52) U.S. Cl. 428/80; 428/195.1

(57) ABSTRACT

The present invention relates to a packaging material, preferably for foodstuffs, for example ice cream in wafers and the like, at least comprising a packaging sheet with an inner side which in a packaged condition, in accordance with requirements, faces towards the packaged goods and with an outer side facing away from the packaged goods, wherein on the outer side of the packaging sheet a composition comprising a colourant and a binder is provided, wherein at least one agent of colourant and binder is a foodstuff or is an agent permitted to come into contact with foodstuffs.

### DESCRIPTION

The present invention relates to a packaging material, preferably for foodstuffs, for example ice cream in wafers and the like, at least comprising a packaging sheet with an inner side which in a packaged condition, in accordance with requirements, faces towards the packaged goods and with an outer side facing away from the packaged goods, wherein on the outer side of the packaging sheet a composition comprising a colourant and a binder is provided, wherein at least one agent comprising colourant and binder is a foodstuff or is an agent permitted to come into contact with foodstuffs.

Packaging material, packagings or packages produced therefrom, for example commercially available ice cream cones, are as a rule handled, for example, stored, transported and/or sold, in the empty condition, i.e. without the packaged goods, in a stacked condition in which at least one portion of an outer side of a packaging is turned towards at least one portion of the inner side of a packaging following in the stacking direction, or in a rolled pack in which at least one portion of an outer side of the rolled packaging material is turned towards at least one portion of the inner side of a packaging material region following in the rolled pack after one revolution.

As a result of printing off in the stack or rolled pack, it is possible for substances, for example printing inks, to be transferred from the outer side of the packaging material or a packaging facing away from the packaged goods in the packaged condition, in accordance with requirements, or on to the inside of the packaging material or a packaging which follows in the stacking direction or rolled pack and which is turned towards the packaged goods in a packaged condition, in accordance with requirements.

When using corresponding packaging material, in particular when filling a corresponding packaging, whose inner side substances have been transferred on to as result of printing off in the stack or rolled pack, with packaged goods, for example a foodstuff, it is thus possible for the packaged goods to come into direct contact with the substance. In this case, the substance can be transferred to the packaged goods in concentrations which are not in conformity with good production practice for foodstuffs or foodstuff manufacturing regulations, for example as stipulated in the Decree (EC) in R.1935/2004 of the European Parliament.

Therefore, printing inks for use on the side of materials or articles facing away from a foodstuff are as a rule provided with an inert lacquer or glaze coating in an additional operation, so that the printing inks cannot be transferred, as a result of printing off in the stack or rolled pack, from the printed surface of a packaging material or a packaging on to the foodstuff contact side of a packaging material or packaging following in the stacking direction or in the rolled pack. The application of the lacquer or glaze coating in an additional operation incurs higher material and production costs.

Starting from the aforementioned state of the art, it is an object of the present invention to make available a packaging material and packagings produced therefrom, which comply with the rules for good manufacturing practice in respect of foodstuffs and which can be made available in a simple and economical manner.

According to the invention, this object is achieved in that a packaging material, in particular for food stuffs, is made available, at least comprising a packaging sheet with an inner side which in the packaged condition, in accordance with requirements, faces towards the packaged goods and with an outer side facing away from the packaged goods, wherein on the outer side of the packaging sheet a composition is provided at least in sections, which contains a colourant and a binder, wherein at least one agent, preferably both agents, comprising colourant and binder is a foodstuff or is an agent permitted to come into contact with foodstuffs.

The composition is preferably edible.

The packaging material according to the invention comprises a packaging sheet. In this case the term packaging sheet comprises any sheet material which can be used for packaging a packaged article. The term denotes both sheet materials from which individual packagings or packages can be formed, for example rolled sheet packaging material from which individual packages can, for example, be formed, cut out or stamped as desired, as well as a ready-formed packaging or packages themselves, for example ice cream cones.

As a result of the application of a composition which contains a colourant and a binder, wherein at least one agent, preferably both agents, of colourant and binder is a foodstuff or is an agent permitted to come into contact with foodstuffs, it is possible to handle correspondingly printed packaging materials stacked or else rolled in the finished or semi-finished state in such a way that non-edible and/or unpalatable substance are not transferred from printed surfaces of a packaging material or a packaging, i.e. in the packaged condition of an outer side facing away from the packaged goods, on to the foodstuff contact side, i.e. the inner side facing towards the packaged goods in the packaged condition, in accordance with requirements, for example as a result of printing off on to a packaging following in the stacking direction.

The subject-matter of the invention thus makes it possible to prevent inedible substances, for example printing ink, from coming into contact with the packaged goods, i.e. in particular a foodstuff, as a result of printing off in the stack or in the rolled pack.

According to the invention, the packaged goods are preferably a foodstuff, for example ice cream cones, i.e. ice cream in wafers.

According to the invention, the term packaging condition denotes a condition in which the packaged goods, preferably an ice cream cone, is accommodated in the packaging, wherein the composition defined according to the invention is provided on the outer side of the packaging, i.e. the side facing away from the packaged goods.

In a preferred embodiment, the packaging material is provided so as to be supplied in a rolled pack.

According to the invention, the term rolled pack denotes a condition in which a one-piece packaging material comprising a packaging sheet is wound in multiple layers about an axis to form a roll, wherein at least one portion of an outer side of the rolled packaging material is turned towards at least one portion of the inner side of a packaging material zone following in the rolled pack after one revolution.

A further preferred embodiment concerns a packaging material which is so formed into a packaging that it can be stacked with similar packaging materials or packagings in a stacking direction so that, in the stacked condition, at least one portion of an outer side of a packaging is turned towards at least one portion of an inner side of a packaging following in the stacking direction.

According to the invention, the term stacked condition denotes a condition comprising at least two packaging materials or packagings, wherein one portion of an outer side of a packaging material or packaging is turned towards at least one portion of an inner side of a packaging material or packaging following in the stacking direction.

The side facing away from the packaged goods, preferably foodstuff, denotes the surface of a packaging material or a packaging which does not come directly into contact with the packaged goods, in particular a foodstuff.

The side or inner side facing towards the packaged goods denotes the surface of a packaging material or a packaging or package which comes directly into contact with the packaged goods, in particular a foodstuff.

In a preferred embodiment, the packaging material and/or the packaging is formed conically, in particular sharply conically, at least in sections but preferably completely. As a result of this conical, in particular, sharply conically shape, it is possible for a plurality of packagings to be stacked in a space-saving manner.

In a further embodiment, the packaging material according to the invention contributes towards a package in which a packaging and/or cover portion is formed at least partly, preferably entirely, from the packaging material. Of course, in particular the cover portion can also be provided consisting of another material, for example paper or cardboard. In an embodiment in which the cover portion is not formed from the packaging material according to the invention, a composition defined in accordance with the Application can likewise be provided on the outer side, i.e. the side of the cover portion facing away from the packaged goods. Preferably, the cover portion is connected in the closed condition in a form-locking manner to the packaging. In this way, the package can be simply closed without additional components.

The composition defined in accordance with the Application can be provided partly or all over the outer side of the packaging material or of the packaging. Of course, the composition defined in accordance with the Application can, in one embodiment, be provided both on the outer side and on the inner side of the packaging material or of the packaging. As a result of all-over application of the composition, the surface of the packaging material according to the invention facing away from the packaged goods can be made available in a single colour.

By applying several different compositions which contain different colourants, the surface of the packaging material facing away from the packaged goods may of course also be multicoloured, for example two or three-coloured.

By means of the composition(s) provided, it is possible to provide on the package information in word and/or image form, for instance the designation of the manufacturer, the designation of the packaged goods contained, for example the variety of ice cream contained, logos, product images, serving suggestions, etc.

In a preferred embodiment, the composition(s) can be applied reversibly to the packaging sheet or to the packaging. They can be removed, for example mechanically, e.g. by scraping, or thermally, e.g. by laser. It is thereby made possible, for example, after all-over application of the composition on the outer side of the packaging sheet or of the packaging, to make information available on the package by subsequent partial removal or washing off of the composition(s).

In a further embodiment, the packaging material according to the invention has at least partly an at least two-layered structure, comprising a first layer which in the packaged condition faces towards the packaged goods, and a second layer which in the packaged condition faces away from the packaged goods and which is formed from a composition defined in accordance with the Application.

The first layer is preferably formed from material containing cellulose, preferably paper.

It is preferred that between the first layer and the second layer at least a third layer is provided, preferably a barrier layer or a plastics material layer, for instance of oriented polypropylene (OPP) or polyethylene terephthalate (PET). The barrier layer may serve, for example, to reduce the permeability of gases, for instance oxygen or water vapour, and thereby to assure the product quality of the packaged goods.

Preferably, the third layer is formed from a material which is chosen from the group comprising polyvinyl alcohol (PVOH), ethylene vinyl alcohol (EVOH), a metal, for example aluminium, a metal oxide, for instance AlxOy, in particular Al₂O₃, SixOy, in particular SiO₂ or generally an oxide of a metal of the second main group of the periodic system of the elements or combinations thereof.

To protect the package contents, i.e. the packaged goods, from UV radiation, for example solar radiation, the barrier layer can be provided with a UV protection medium, for example benzotriazole.

In a preferred embodiment of the invention, the packaging material has a three-layered structure. In this case, the layer facing towards the packaged goods is preferably paper, the barrier layer preferably comprises aluminium and the second layer a composition defined in accordance with the Application. Especially preferably, the aluminium is laminated on to the paper.

The first layer and optionally further layers, for example a barrier layer, form the packaging sheet.

In a preferred embodiment, the composition further comprises a coating medium and/or a defoaming agent.

The composition preferably comprises approximately 0.01% by weight to approximately 8% by weight colourant, preferably approximately 0.1% by weight to approximately 6.0% by weight colourant, approximately 0.1% by weight to approximately 1% by weight coating medium, preferably approximately 0.3% by weight to approximately 0.6% by weight coating medium and/or approximately 90% by weight to approximately 99% by weight binder, preferably approximately 95% by weight to approximately 99% by weight binder.

If not otherwise indicated, the percent by weight (% by weight) details refer to the total weight of the composition in the dry state, i.e. the weight after the application and curing of the composition on the packaging material.

Examples of compositions are
a) 98.75% by weight binder, 0.42% by weight wax and 0.83% by weight colourant, wherein the basic wet formulation comprises 0.3% by weight colourant.
b) 96.85% by weight binder, 0.41% by weight wax and 2.74% by weight colourant, wherein the basic wet formulation comprises 1.0% by weight colourant.
c) 94.20% by weight binder, 0.40% by weight wax and 5.40% by weight colourant, wherein the basic wet formulation comprises 2.0% by weight colourant.

The colourant in accordance with the present Application comprises food dyes, foodstuff with inherent colouring (e.g. cocoa, coffee, nettle juice, spinach, red beetroot juice, etc.) or combinations thereof.

The colourant can be of vegetable origin, for example chlorophyll or a synthetic imitation of naturally occurring substances, i.e. a nature-identical agent or a synthetic compound.

Preferably, the colourant is a material which is used or permitted as a foodstuff additive in the food industry, or is edible.

In an especially preferred embodiment, the colourant used according to the invention is a foodstuff dye which is permitted throughout the EU as a food dye and/or is chosen from the group comprising Allura red AC (E 129), aluminium (E 173), amaranth (E 123), anthyocyanins (E 163), azorubine (E 122), betanin (E 162), brown FK (E 154), brown HT (E 155), brilliant blue FCF (E 133), brilliant black BN (E 151), calcium carbonate (E 170), canthaxanthin (E 161g), carotene (E 160a), annatto (norbixin) (E 160b), capsanthian (E 160c), lycopene (E 160d), 8′-apo-β-carotene-8′-al (E 160e), ethyl-8′-apo-β-carotene-8′oat (E 160f), quinoline yellow (E 104), chlorophyll (E 140), cochineal red A (E 124), curcumin (E 100), iron oxide (E 172), erythrosin (E 127), yellow orange S (E 110), gold (E 175), green S (E 142), indigotine (E 132), cochineal (E 120), copper-containing complexes of chlorophylls and chlorophyllines (E 141), lactoflavin (E 101), lithol ruby BK (E 180), lutein (E 161b), patent blue V (E 131), vegetable carbon (E 153), riboflavin (vitamin B2) (E 101), riboflavin-5-phosphate (E 101a), saflor, silver (E 174), tartrazine (E 102), titanium dioxide (E 171), sugar colouring (E 150a), caustic sulphite sugar colouring (E 150b), ammonia sugar colouring (E 150c), ammonium sulphite sugar colouring (E 150d), zeaxanthin (E 161h) and combinations thereof.

A binder, or thickening agent, in accordance with the present Application is any medium which, as a rule, is added to aqueous solutions so as to increase their viscosity. Therefore, binders or thickening agents are substances which are able to bind water.

In the composition used according to the invention, binders are used, inter alia, to retard undesirable separation processes during storage, for example phase separation, or settling of particles.

Binders used according to the invention are preferably thickening agents which are used in the food industry or in the pharmaceutical industry and/or are permitted as food additives.

Preferred binders are chosen from the group comprising polyacrylic acid (carbopol) and polyacrylic acid derivatives, polyethylene glycol and polyethylene glycol derivatives, cellulose derivatives, alginic acid (E 400), agar (E 406), carrageenan (E 407), carob bean flour (E 410), guar flour (E 412), tragacanth (E 413), gum arabic (E 414), xanthan (E 415), karaya (E 416), tara flour (E 417), gellan (E 418), pectin (E 440), cellulose (E 460), cellulose ether, carboxy methyl cellulose (E 466), hydroxy propyl cellulose (E 463), hydroxy propyl methyl cellulose (E 464), methyl cellulose (E 461), methyl ethyl cellulose (E 465), modified starch (group: E 1404,-10,-12,-14,-20,-22,-40,-42,-50,-51) and combinations thereof.

In an especially preferred embodiment of the present Application, the binder of the wet formulation of the composition used according to the invention is an aqueous acrylate dispersion, preferably comprising approximately 30 to 50% by weight acrylate, more preferably approximately 35 to 45% by weight acrylate and most preferably approximately 40% by weight acrylate and approximately 50 to 70% by weight water, more preferably approximately 55 to approximately 65% by weight water and most preferably 60% by weight water. In the dry state, accordingly, the binder is preferably an acrylate.

Coating medium in accordance with the present Application is any food additive which protects edible media, for example foodstuffs, from loss of aroma, taste and moisture, promotes glaze or prolongs freshness or else can function as a release agent.

Preferably, the coating medium contained in the composition according to the invention is a wax, for example a natural wax or an animal wax or mixtures thereof. Preferred natural, vegetable waxes are carnauba wax (E 903), benzoin wax 906) and candelilla wax (E 902). A preferred animal wax is beeswax (E 901). Of course, synthetic waxes, for example polyethylene-based waxes, can also be used.

Other coating media which can be used according to the invention comprise, for example, mono- and diglycerides of edible fat acids (E 507), cellulose, for example carboxy methyl cellulose (E 466), hydroxy propyl cellulose (E 463), hydroxy propyl methyl cellulose (E 464), methyl cellulose (E 461), methyl ethyl cellulose (E 465), polyvinyl pyrrolidone (E1202), polyvinyl pyrrolidone (E 1201) and shellac (E 904) and combinations thereof.

A defoaming agent in accordance with the present invention is an antifoaming agent. The defoaming agent is an additive which reduces or prevents undesirable foaming in the production or processing of foodstuffs. Preferred defoaming agents comprise organically modified polysiloxane, for instance methyl polysiloxane (E 900), and mono- or diglycerides of a fatty acid (E 471).

In addition to colourants, binders, coating media and defoaming agents the composition may contain further agents, for example antioxidants or stabilisers.

The composition comprises water, in addition to colourants, binders, coating media and defoaming agents and also optionally one or more further media.

In an especially preferred embodiment, the composition consists of colourants, binders, coating media and defoaming agents in the above-defined percentage by weight data and water.

In a further preferred embodiment of the present invention, all the constituents of the composition, i.e. colourants, binders, coating media and defoaming agents, are permitted as foodstuffs or as food additives or for contact with foodstuffs. Especially preferably the composition is edible.

A further subject-matter of the present invention is the use of a composition which contains a colourant and a binder, wherein at least one agent, preferably both agents, of colourant and binders is a foodstuff or is an agent permitted to come into contact with foodstuffs, and which is optionally characterised by at least one further composition feature as defined in the present Application, for the printing of at least partly, preferably completely inedible packaging material or packagings, in particular foodstuff packaging material.

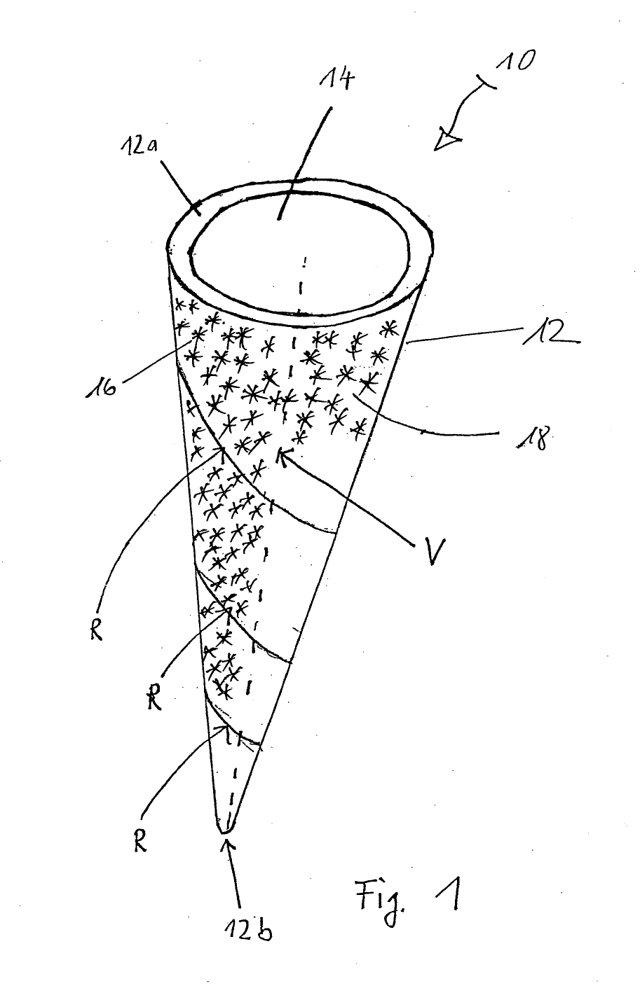

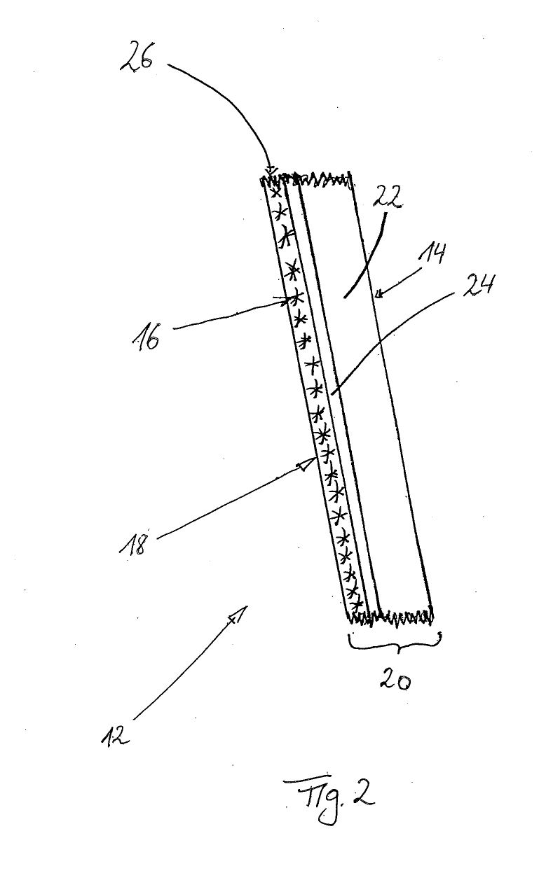

The present invention will be illustrated in more detail by way of example below with reference to FIGS. 1 and 2.

FIG. 1: An embodiment of a packaging comprising packaging material according to the invention, in a view in perspective.

FIG. 2: Laminar construction of the packaging according to FIG. 1.

In FIG. 1 a packaging according to the invention is denoted by the reference numeral 10. The sharply conical packaging 12 extends along a packaging axis V and tapers from a removal end 12a of large package cross-section to a point 12b at the longitudinal end of the packaging 12 axially opposite the removal end 12a with regard to the packaging axis V. The peripheral line R of the radially outer peripheral zone of the circumferential surface of the packaging 12 is formed, preferably helically, from a flat material sheet so as to provide an as fluid-tight as possible packaging 12. The circumferential surface of the packaging 12 can be sealed in portions in which it overlaps itself owing to its helical configuration, in particular in the vicinity of the peripheral line R. The packaging 12 has an inner side 14 which in the stipulated condition faces towards the packaged goods and which in the example illustrated is not printed with a composition 16 (symbolised by asterisks). The packaging 12 also comprises an outer side 18 which in the stipulated condition faces away from the packaged goods and which is printed with a composition 16 (symbolised by asterisks).

FIG. 2 illustrates a preferred laminar construction of a multilayer structure 20 of the packaging 12. The multilayer structure 20 comprises a first layer 22 which in the stipulated condition faces towards the packaged goods and which preferably is formed from paper. The layer 22 forms the inner side 14 in the packaging 12. The multilayer structure 20 further comprises a barrier layer 24 which is preferably formed from aluminium and is laminated on to the layer 22. A composition 16 (symbolised by asterisks) forms the layer 26. Preferably, the layer 26 is formed all over the surface. However, the layer 26 can of course take the form of patterns and/or text. The layer 26 forms in the stipulated condition of the package according to the invention the outer side 18 facing away from the packaged goods.

1. A packaging material, in particular a foodstuff packaging material, at least comprising a packaging sheet with an inner side (14) which in a packaged condition, in accordance with requirements, faces towards the packaged goods and with an outer side (18) facing away from the packaged goods,
characterised in that on the outer side (18) of the packaging sheet a composition (16) is provided at least in sections, which comprises a colourant and a binder, wherein at least one agent, preferably both agents, of colourant and binder is a foodstuff or is an agent permitted to come into contact with foodstuffs.

2. A packaging material according to claim 1, characterised in that the packaging material is provided so as to be supplied in a rolled pack.

3. A packaging material according to claim 1, characterised in that the packaging material is so formed into a packaging (12) that it can be stacked with similar packaging materials in a stacking direction so that, in the stacked condition, at least one portion of an outer side (18) of a packaging (12) is turned towards at least one portion of an inner side (14) of a packaging (18) following in the stacking direction.

4. A packaging material according to claim 3, characterised in that the packaging (12) is formed, at least in sections, preferably completely conically, in particular sharply conically.

5. A packaging material according to claim 4, characterised in that it contributes towards a package in which a packaging and/or cover portion is formed at least partly, preferably entirely, from the packaging material.

6. A packaging material according to claim 5, characterised in that, in the closed condition of the packaging, the cover portion is connected in a form-locking manner to the packaging.

7. A packaging material according to claim 1, characterised in that the composition (16) is applied all over the outer side (18) of the packaging sheet or of the packaging (12).

8. A packaging material according to claim 1, characterised in that the composition (16) is applied reversibly to the packaging sheet or to the packaging (12), for example, it can be removed mechanically or thermally.

9. A packaging material according to claim 1, characterised in that the packaging sheet or the packaging has at least partly an at least two-layered structure, comprising a first layer (22) which in the packaged condition faces towards the packaged goods, and a second layer (26) which in the packaged condition faces away from the packaged goods and which is formed from the composition (16).

10. A packaging material according to claim 9, characterised in that the first layer (22) is formed from material comprising cellulose, preferably paper.

11. A packaging material according to claim 9, characterised in that a third layer, preferably a barrier layer (24), is provided between the first and second layers (22,26).

12. A packaging material according to claim 9, characterised in that the third layer is formed from a material which is chosen from the group comprising polyvinyl alcohol (PVOH), ethylene vinyl alcohol (EVOH), a metal, for example aluminium, a metal oxide, for instance AlₓO_{y}, in particular Al₂O₃, SiₓO_{y}, in particular SiO₂ or generally an oxide of a metal of the second main group of the periodic system of the elements or combinations thereof.

13. A packaging material according to claim 1, characterised in that the composition (16) further comprises a coating medium and/or a defoaming agent.

14. A packaging material according to claim 1, characterised in that the composition (16) preferably comprises approximately 0.01% by weight to approximately 8% by weight colourant, preferably approximately 0.1% by weight to approximately 6.0% by weight colourant, approximately 0.1% by weight to approximately 1% by weight coating medium, preferably approximately 0.3% by weight to approximately 0.6% by weight coating medium and/or approximately 90% by weight to approximately 99% by weight binder, preferably approximately 95% by weight to approximately 99% by weight binder.

15. A packaging material according to claim 1, characterised in that the colourant is a food dye, a foodstuff with inherent colouring or a combination thereof.

16. A packaging material according to claim 15, characterised in that the food dye is chosen from the group comprising Allura red AC (E 129), aluminium (E 173), amaranth (E 123), anthyocyanins (E 163), azorubine (E 122), betanin (E 162), brown FK (E 154), brown HT (E 155), brilliant blue FCF (E 133), brilliant black BN (E 151), calcium carbonate (E 170), canthaxanthin (E 161g), carotene (E 160a), annatto (norbixin) (E 160b), capsanthian (E 160c), lycopene (E 160d), 8′-apo-β-carotene-8′-al (E 160e), ethyl-8′-apo-β-carotene-8′oat (E 160f), quinoline yellow (E 104), chlorophyll (E 140), cochineal red A (E 124), curcumin (E 100), iron oxide (E 172), erythrosin (E 127), yellow orange S (E 110), gold (E 175), green S (E 142), indigotine (E 132), cochineal (E 120), copper-containing complexes of chlorophylls and chlorophyllines (E 141), lactoflavin (E 101), lithol ruby BK (E 180), lutein (E 161b), patent blue V (E 131), vegetable carbon (E 153), riboflavin (vitamin B2) (E 101), riboflavin-5-phosphate (E 101a), saflor, silver (E 174), tartrazine (E 102), titanium dioxide (E 171), sugar colouring (E 150a), caustic sulphite sugar colouring (E 150b), ammonia sugar colouring (E 150c), ammonium sulphite sugar colouring (E 150d), zeaxanthin (E 161h) and combinations thereof.

17. A packaging material according to claim 1, characterised in that the binder is an acrylate.

18. A packaging material according to claim 13, characterised in that the coating medium is a wax, for example a natural vegetable wax, for example carnauba wax (E 903), benzoin wax (E 906), candelilla wax (E 902) or an animal wax, for example beeswax (E 901), or a synthetic wax, for example polyethylene-based, or a mixture thereof.

19. A packaging material according to claim 13, characterised in that the wax and the defoaming agent, for example an organically modified polysiloxane, such as dimethyl polysiloxane (E 900), or a mono- or diglycerides of a fatty acid (E 471), are permitted as a food additive and for contact with foodstuffs.

20. Use of a composition which contains a colourant and binder, wherein at least one agent, preferably both agents, of colourant and binder is a foodstuff or is an agent permitted to come into contact with foodstuffs, and which is optionally characterised by at least one further composition feature as defined in claim 1, for the printing of at least partly, preferably completely inedible packaging material or packagings, in particular foodstuff packaging material.
